(19) United States
(12) Patent Application Publication
(10) Pub. No.: US 2017/0053762 A1
(43) Pub. Date: Feb. 23, 2017

(54) RELAY WITH INTEGRAL WIRELESS TRANSCEIVER FOR COMMUNICATION AND CONTROL

(71) Applicant: TYCO ELECTRONICS CORPORATION, Berwyn, PA (US)

(72) Inventors: Alexander Raymond KING, Lancaster, PA (US); Annie Hanna CHANG, Sugar Land, TX (US)

(21) Appl. No.: 15/238,949

(22) Filed: Aug. 17, 2016

Related U.S. Application Data
(60) Provisional application No. 62/208,277, filed on Aug. 21, 2015.

(51) Int. Cl. H01H 50/54; G05B 15/02; H01H 50/44; H01H 47/22; H04B 1/38; H04W 4/00

(52) U.S. Cl. CPC H01H 50/54; H04B 1/38; H04W 4/008; H01H 50/44; H01H 47/223; G05B 15/02

(57) ABSTRACT

An electro-mechanical relay with at least one pair of switchable electrical contacts includes a wireless communications control function. The wireless communications control function may be a receiver or a transceiver and may be within a relay housing. A cloud server may be connected, via the Internet or wirelessly via a router, in data communication with one or more process locations. Each process location comprises one or more relays capable of receiving wireless communications from a router. The router/wireless interface in wireless communication with a local plant system to transmit control signals from the building management system to the local plant system for controlling the operation of equipment within the local plant. The relays are configured to wirelessly receive operational instructions and to provide operational feedback information to the building management system.

This application claims priority from and the benefit of U.S. Provisional Patent Application No. 62/208,277, entitled ELECTRO-MECHANICAL RELAY SWITCH WITH INTEGRAL WI-FI CONTROL filed Aug. 21, 2015, which is hereby incorporated by reference.

### FIELD OF THE INVENTION

The present invention is directed to an electro-mechanical relay. The application relates more specifically to an electro-mechanical relay with integral wireless network communication and control functionality.

### BACKGROUND OF THE INVENTION

Current remote control of electro-mechanical relays requires either a wired connection for transmitting an actuation signal or connection to a local discrete wired or wireless controller. Current wireless relay modules may incorporate a wireless control and relay switch into a single housing but the addition of the wireless control and relay switch increases the overall relay module footprint in order to supply the wireless control functionality.

What is needed is a compact electro-mechanical relay with integral wireless control functionality via wireless communication control—e.g., Wi-Fi—without requiring external discrete communication modules or an additional housing which includes both relay and communication modules.

### SUMMARY OF THE INVENTION

In one embodiment a conventional electro-mechanical relay with at least one pair of switchable electrical contacts includes a wireless communications chipset mounted integrally within a relay housing, the relay housing being a standard dimension and form factor for existing electro-mechanical relays.

A cloud server may be connected via the Internet in data communication with one or more process locations, each process location comprising one or more relays connected to a gateway through a plurality of electrical conductors or wireless communication channels; a gateway in data communication with the Internet and a router; the router in data communication with a local plant operation to transmit data from the gateway to the local plant operation for operating equipment within the local plant operation.

One advantage of the invention is a compact electro-mechanical relay with integral wireless control functionality via wireless communication control—e.g., Wi-Fi, Bluetooth, ZigBee, LoRaWAN, NFC (near field communication), RFID (radio frequency identification), or any other wireless communication protocol having a transmitter and receiver operating in the Radio Frequency (RF) spectrum—without requiring external discrete communication modules or an additional housing which includes both relay and communication modules.

Another advantage of the invention is an electro-mechanical relay that provides wireless communication control entirely within the footprint and form factor of existing relay production units, e.g. Schrack Power PCB Relay RZ, or Potter & Brumfield T9A platform.

Another advantage is the modification of a production-volume electro-mechanical relay device to include wireless communication control without increasing the form factor.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a system overview of an exemplary embodiment of a relay platform.

FIG. 2 illustrates a schematic diagram of a relay incorporating the wireless communications control within a conventional relay footprint.

FIG. 3A illustrates an exemplary electro-mechanical relay in a sectional perspective view with integral wireless communication control functionality.

FIG. 3B illustrates an assembled relay with a cover installed.

FIG. 4 illustrates an enlarged prior art relay board with a wireless module socket on a circuit board.

FIG. 5 illustrates another enlarged prior art relay board with a wireless module on a circuit board having an antenna coupled thereto for wireless communications.

FIG. 6A illustrates a fully assembled relay in a typical configuration.

FIG. 6B illustrates the relay with exposed internal wiring connecting the wireless transceiver board with the relay actuation coil.

FIG. 6C illustrates a relay containing a wireless transceiver with cover replaced.

FIG. 6D illustrates a relay fully assembled with all wireless transceiver circuitry integrated.

### DETAILED DESCRIPTION OF THE INVENTION

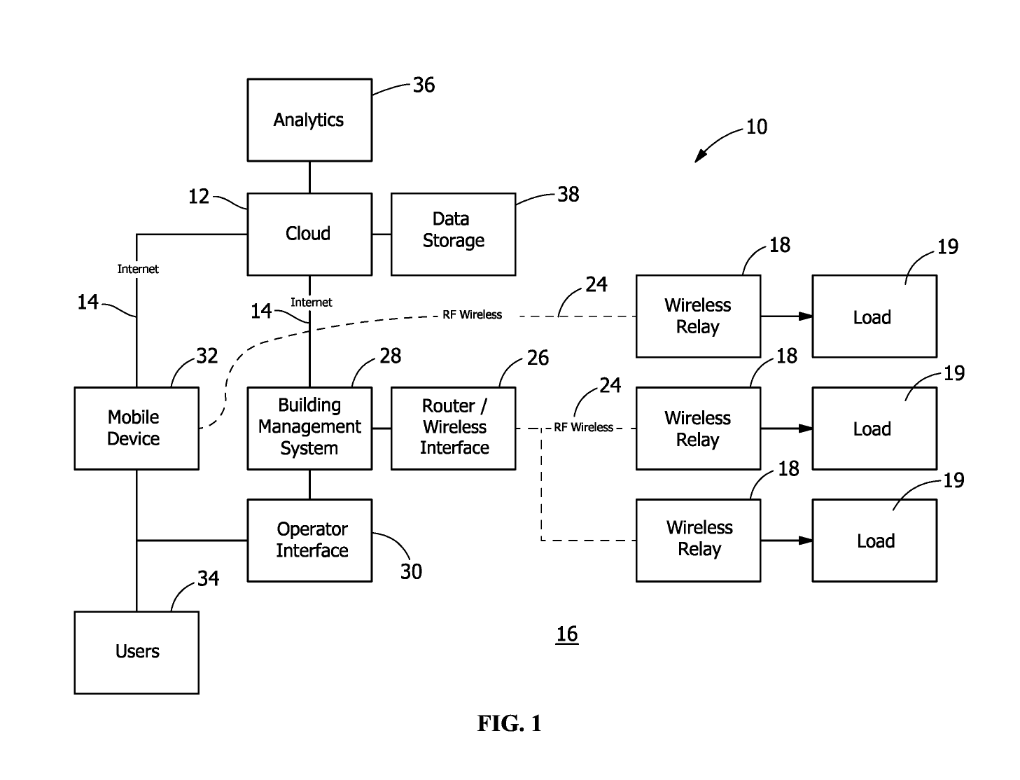

Referring to FIG. 1, a system overview of an exemplary embodiment of a relay platform, or system, 10 is shown. Included in FIG. 1 is one possible implementation of a cloud 12 or cloud services system to be used in conjunction with a wireless relay 18. The cloud includes any number of internet or intranet-connected servers which operate for the purposes of receiving, sending, storing via data storage 38, or acting on data generated by or related to wireless relay 18. Included in the possible data actions are analytics 36. Examples of analytics include trend monitoring, predictive modeling, historical data processing, and simulation. The results of these data processing actions can be reported via internet 14 to building management systems 28 or other connected devices 32 for further processing or user interaction. A cloud server 12 is connected via the Internet 14 in communication with one or more process locations 16. Each process location 16 includes one or more relays 18 connected to a router 26, building management system 28, operator interface 30, mobile device 32, or wireless interface router 26, which may be connected to the Internet 14 and is in data communication with a local plant management system 28, e.g., a microprocessor or computer-controlled building management system, an industrial process control system, or similar microprocessor or computer-controlled environment. Router 26 provides a communications interface between equipment controlled by the building management system and the building management system 28. Router 26 transmits wireless communications to and receives wireless communications from, inter alia, relays 18, each of which controls a subsystem load 19 of the building management system 28. Data signals may include relay signals from contacts on the relays 18.

Building management system 28 may include a dashboard as part of the operator interface 30 for an operator 34 in the local building or plant. The operator interface 30 is configured to display information available in the microprocessor or computer relating to the building management system 28, for example, as historical data, graphs, equipment properties, trends, flow diagrams, operating conditions, parameters, parameter set points and additional information. The displayed data can be observed by an operator to evaluate how the building system is operating. Control parameter set points can be updated, modified or over-ridden and replacement or auxiliary equipment can be acknowledged as added to control a subsystem load 19 of equipment controlled by the building management system using the operator interface 30. The microprocessor or computer operates on a predetermined set of instructions and may be coupled to the Internet 14 such that an operator can access the operator interface 30 over the Internet 14, for example using a computer or a mobile device, at a location remote from the physical location of the building management system. Once the operator interface is accessed, the operator can intervene in control of the building management system in any manner needed, including modifying one or more of the predetermined set of instructions, changing parameter set points, or any other function the operator is authorized to undertake.

System 10 may also be configured to include communications to one or more mobile computing devices 32, including but not limited to smart phones, tablet computers, portable personal computers, and similar devices capable of wireless communication or communication via the Internet. Mobile devices 32 may be used by building operators or personnel 34 to monitor and/or control plant operations from remote locations, or from locations within the local plant operation. It should be understood that FIG. 1 is an exemplary embodiment, and more or less process locations, relays, routers, and other components may be configured in a variety of ways using the relays mobile devices 32 including personal computers, router/wireless interface 26, and operator interface 30 to control multiple process locations and operations.

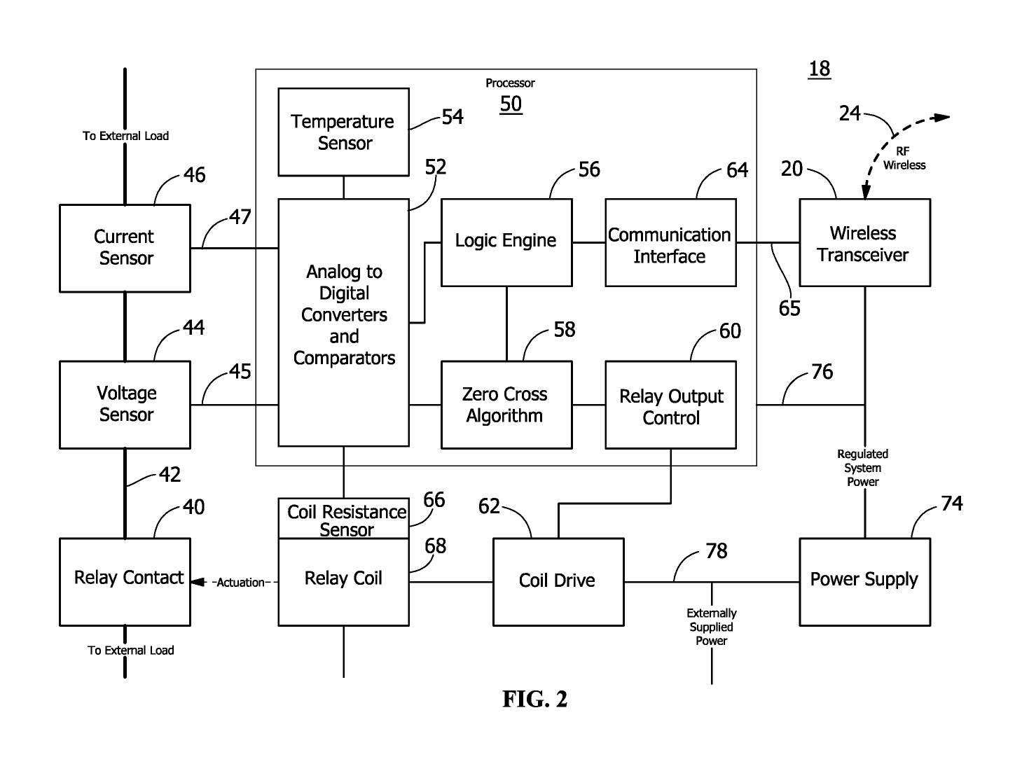

Referring next to FIG. 2, one exemplary relay configuration that may be used to implement system 10 is shown. A relay contact or switch element 40 of an electro-mechanical relay controls on/off electrical current and voltage signals via a conductor or conductors 42. The relay has at least one pair of switchable electrical contacts. When the relay actuates, the contacts transition from a first state to a second state. If in the first state, the contacts are open, in the second state the contacts will be closed. Conversely, if the contacts are closed in the first state, the contacts will be opened in the second state. Although the invention will be described with respect to at least one pair of contacts, the invention is not limited thereto. Some embodiments of the invention may have multiple pairs of contacts. For example, a relay with two pairs of contacts could have one pair of normally open contacts and a pair of normally closed contacts, both pairs of contacts that are normally open, or both pairs of contacts that are normally closed.

The following description includes optional features associated with a relay having an internal sensor and zero-crossover switching. It should be noted that not all embodiments of the invention require such features and that a conventional electro-mechanical relay with basic coil and contact features, including a wireless communication control function to initiate and control actuation of the relay coil, is within the scope of the invention.

A voltage sensor 44 and a current sensor 46 may be provided to sense voltage and current, respectively, on the conductor 42 and transmit a voltage sensor signal 45 and a current sensor signal 47 to a microcontroller 50, which processes the voltage sensor signal 45 and a current sensor signal 47 as will be described in more detail below.

A microcontroller 50 may be provided in the relay that includes an analog-to-digital conversion and comparator module 52 that receives the voltage sensor signal 45 and a current sensor signal 47 inputs, as well as inputs from a coil resistance sensor 66 and a temperature sensor 54, for example, within the relay housing 3. Coil resistance sensor 66 senses the resistance of a relay actuation coil 68 of the electro-mechanical relay. Temperature sensor 54 senses the operating temperature of the electro-mechanical relay. Analog-to-digital converter 52 converts the analog signals from voltage sensor signal 45 and a current sensor signal 47 into digital signals for input to a logic engine and program memory module 56. Logic engine/program memory module 56 performs digital logic operations for monitoring threshold parameters associated with the electro-mechanical relay, and for switching logic.

An adaptive zero-crossover switching algorithm module 58 is provided to implement an adaptive zero-crossover switching algorithm that controls a relay control output module 60. The relay control output module 60 and the logic engine/program memory module 56 exchange data related to zero-crossover switching of contacts 40. Zero-crossover provides a method of controlling the timing of relay contact closure to occur at the crossover point of the voltage waveform such that the potential between the relay contacts is less than the dielectric strength of the inter-contact insulator (e.g., air, nitrogen, etc.), thereby obviating arcing and other concomitant effects, including heat generating effects that may diminish the operating life of the relay contacts. One example of a relay with zero-crossover switching is disclosed in commonly owned and co-pending U.S. patent application Ser. No. 14/563,452, filed Dec. 8, 2014, entitled “RELAY WITH INTEGRAL PHASE CONTROLLED SWITCHING”, which is hereby incorporated by reference.

Comparators in the analog-to-digital conversion module 52 provide information describing the state of sensor signals as being either higher than or lower than a defined threshold voltage. This information is communicated to the adaptive zero-crossover switching algorithm module 58. The adaptive zero-crossover switching algorithm module 58 receives logic switching commands from logic engine/program memory module 56 and generates control output signals to a relay control output module 60. Relay control output module 60 powers a coil drive 62 that drives relay coil 68 in synchronization with the line voltage on conductor 42 to effect the zero-voltage crossover switching. Relay control output module 60 may power a dual-stage a coil drive as is known in the relay art. A larger current is provided to actuate the relay coil and subsequent to actuation, a smaller current is provided to retain the relay coil in the actuated state.

Microcontroller 50 further includes a communication interface 64 that provides output signals to and receives input signals from wireless transceiver 20. The input and output signals are designated 65. Wireless transceiver 20 is configured is configured to communicate with router 26 to receive identifying information and establish a wireless link between the relay 18 and router 26. Wireless transceiver 20 receives operational instructions from router/wireless interface 26 for relay 18 to energize or de-energize the relay coil 68 and to provide operational feedback information. Wireless transceiver 20 is also capable of transmitting data via RF wireless link 24 to be received by router/wireless interface 26. This transmitted data may contain information about the operation or performance of the relay e.g. coil resistance, relay temperature, number of relay cycles, or load current. Power supply 74 receives power from the externally supplied power source which also provides power to the coil drive 62, via line 78. Power supply 74 provides power to both wireless transceiver 20 and microcontroller 50 via line 76.

In addition to having at least one pair of contacts 40 as described above, relay 18 has a coil 68 for actuating the contacts 40. Relay 18 also has a wireless communication control circuit 20 for receiving a signal to initiate energizing the coil 68. Energizing the coil 68 changes the state of the at least one pair of switchable contacts 40 from a first state to a second state. De-energizing the coil 68 will allow the relay to de-actuate returning the at least one pair of switchable contacts 40 to return to the first state from the second state. While relay 18 comprises at least a receiver to receive wireless communications from router 26 to actuate and to de-actuate coil 68, preferably relay 18 comprises a transceiver in wireless communication control circuit 20 to both receive communications from router 26 and to transmit communications to router 26.

Examples of data generated by relay 18 that can be transmitted wirelessly to router 26 and thus be used in the building management system 28, in analytics 36, stored in data storage 38, used in the cloud 12, or displayed on the operator interface, include but are not limited to those properties listed below. With passive or active electronics, or both, built into a relay, several properties can be measured or calculated and transmitted to the router 26 wirelessly. A cycle count of the number of times relay 18 on and off. The cycle count is useful for relay lifetime predictions to have spare parts readily available to avoid down time. The total time relay 18 is on, meaning the aggregated duration of time passed during which the coil was actuated and the coil was held in the actuated position. The coil resistance, for example measured in ohms, as an indicator of relay integrity. Contact voltage, for example measured in volts, as an indication of the line voltage. Contact current, for example measured in amperes, which is useful for understanding whether the load is operating within specification. Switching time, for example measured in milliseconds, to evaluate the time taken between the coil energizing and closure of the contacts. The internal temperature of the relay, for example measured in degrees Fahrenheit or Celsius.

In addition to operational parameters, the relay can store and report identifying information such as the relay serial number or another unique identifier, the manufacturer and part number, and in a user defined field any information the user would find useful, for example, installation location or connected load information.

Any of the information that can be transmitted by relay 18 to router 26 could be broadcast periodically by relay 18, or queried by the building management system 28 or an operator through the operator interface 30 or a mobile device 32. The data, once transmitted to router 26, can be used locally at process location 16, or it can be displayed in the operator interface 30, or used in the cloud for analytics 36 and decision making.

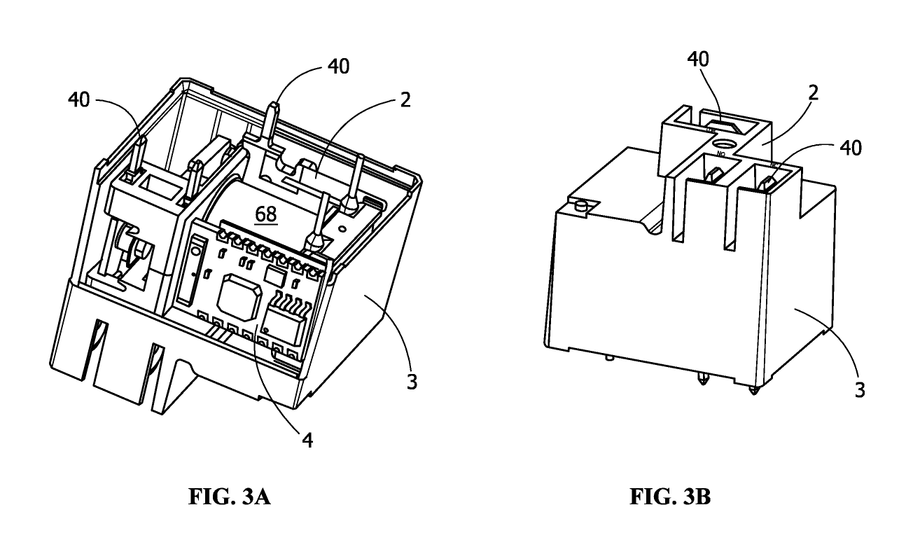

FIGS. 3A and 3B illustrate an exemplary electro-mechanical relay 2 with integral wireless communication control functionality. In FIG. 3A a wireless communication control chipset 4 is shown in a sectional perspective view of the relay 2, wherein the chipset 4 is installed adjacent to a relay coil 68. FIG. 3B shows the assembled relay 2 with a cover 3 installed. External contacts 40 are visible in both FIGS. 3A and 3B.

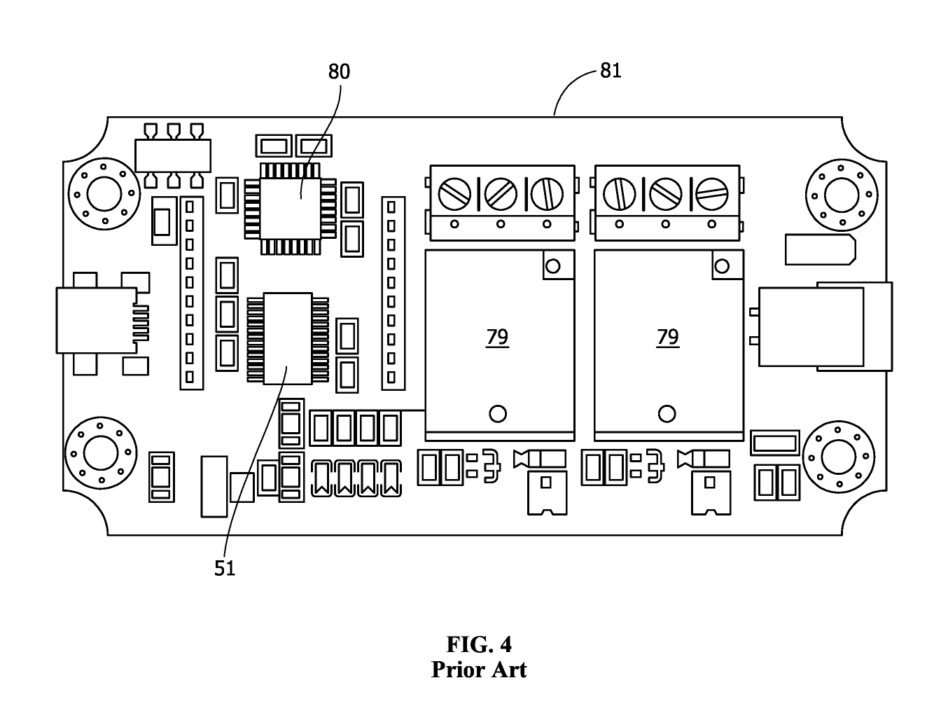

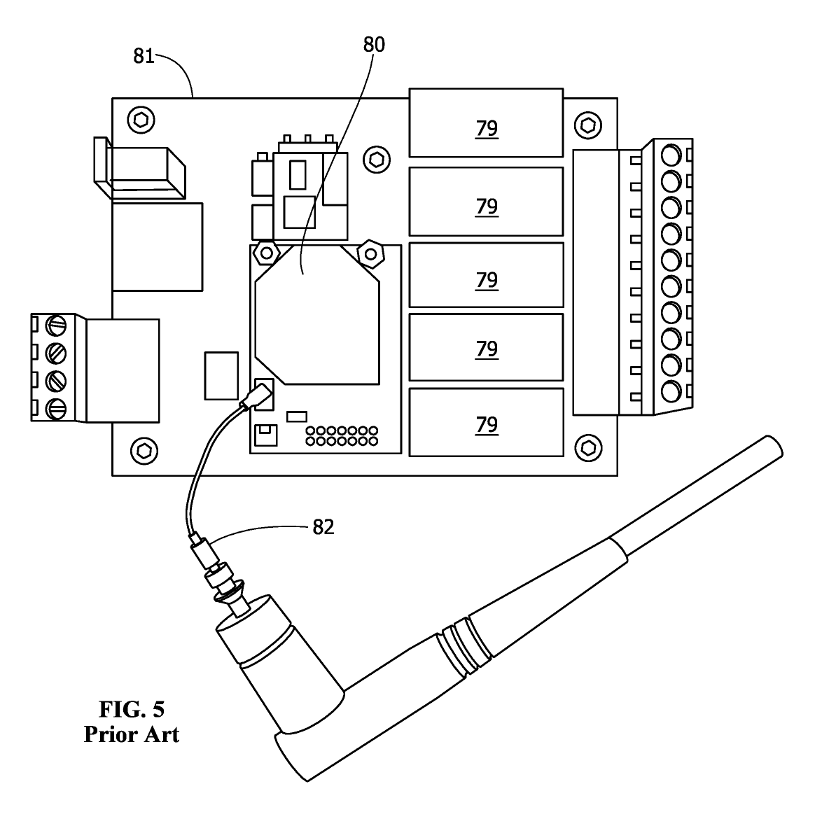

FIGS. 4 and 5 illustrate prior art techniques. The prior art techniques are defined by an integration hierarchy that has at its highest level a printed circuit board 81 on which the relay 79, or relay devices, processor 51 and wireless transceiver 80 are discrete subsystems placed on the printed circuit board 81 to establish a physical communication layer between the subsystems. Some prior art techniques require the use of a discrete antenna 82 (FIG. 5) for data transmission and reception via RF wireless signals.

In some embodiments, microprocessor or microcontroller 50 controls relay coil 68 which is a portion of wireless electro-mechanical relay 18 by controlling the current to the relay coil 68.

A dual drive close and hold current can be generated to drive the relay coil. Full power is provided to actuate the relay by a larger current and a reduced drive current is used to hold the relay in the actuated state until microcontroller 50 signals to de-actuate relay 18. Microcontroller 50 includes an analog-to-digital converters to digitize the zero cross signal input for processing.

An integral diode clamp may be provided for EMI reduction.

Current sensing may be provided in relay 18 for over current protection. Over current protection can be provided in the form of shutting off the relay if the current exceeds a predetermined or dynamic threshold. Temperature sensing may be provided for overcurrent protection and operating environment monitoring. Thermal protection may also be provided in the form of shutting off the relay if the temperature exceeds a predetermined or dynamic threshold.

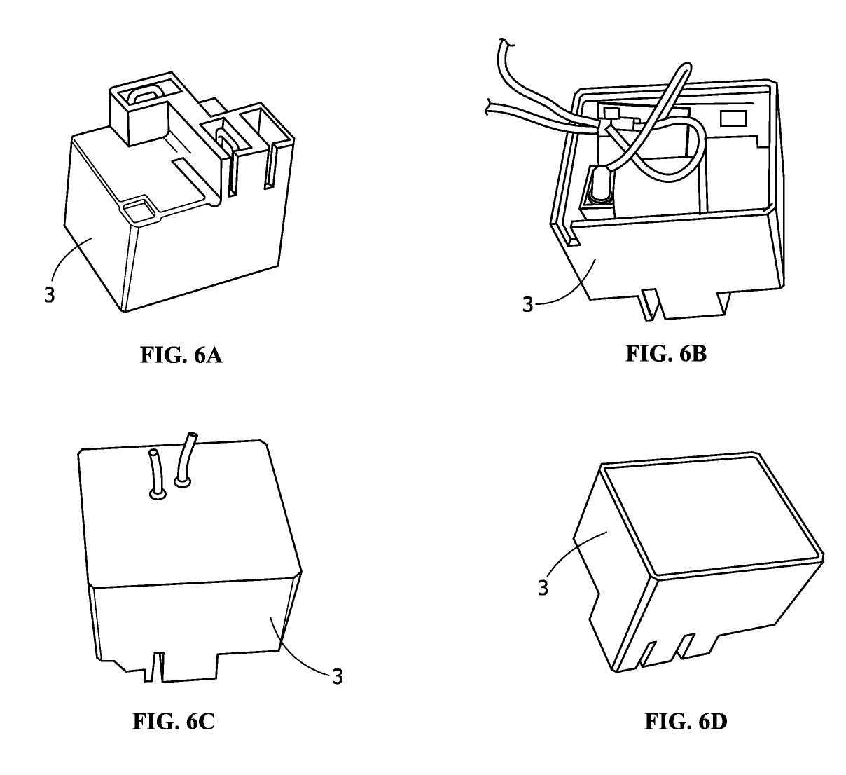

FIGS. 6A, 6B, 6C, and 6D show a prototype wireless communication control relay 18 in various stages of assembly and arrangements. FIG. 6A shows relay 18 full assembled in a typical configuration. FIG. 6B shows relay 18 shows exposed internal wiring which connects the wireless transceiver board with the relay actuation coil. FIG. 6C shows relay 18 shows a relay containing wireless transceiver with cover replaced, and debug or prototyping test leads exposed. FIG. 6D shows relay 18 shows a relay fully re-assembled and ready for deployment, with all wireless transceiver circuitry integrated.

While embodiments of the invention have been described as the relay having a transceiver, the invention is not limited thereto. A relay having a receiver that is capable of receiving a control signal, by a wireless communication that initiates actuation or de-actuation of the relay is also considered within the scope of the invention.

While the invention has been described with reference to one or more embodiments, it will be understood by those skilled in the art that various changes may be made and equivalents may be substituted for elements thereof without departing from the scope of the invention. For example, while the invention has been described in an embodiment of a building maintenance system, the invention is not limited thereto. The invention is also applicable to other industrial plant operations. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electromechanical relay comprising:
at least one pair of switchable electrical contacts;
a coil for actuating the at least one pair of contacts; and
a wireless communication control circuit for receiving a signal to initiate energizing the coil and concomitantly change the state of the at least one pair of switchable contacts from a first state to a second state.

2. The relay as recited in claim 1, wherein the wireless communication control circuit comprises a receiver.

3. The relay as recited in claim 2, further comprising a transceiver for receiving a signal to initiate energizing the coil.

4. The relay as recited in claim 3, wherein the relay provides operational feedback.

5. The relay as recited in claim 4, wherein the relay provides operational feedback selected from the group consisting of a cycle count, an aggregated time the relay has been powered, a coil resistance, a contact voltage, and an internal temperature of the relay.

6. The relay as recited in claim 4, wherein the relay provides operational feedback at a time selected from the group consisting of broadcast periodically and when queried.

7. The relay as recited in claim 1, further comprising a dual-stage coil drive wherein a larger current is provided to actuate the relay coil, and subsequent to actuation, a smaller current is provided to retain the relay coil in an actuated state.

8. The relay as recited in claim 1, further comprising:
an input line on which to receive an AC voltage;
a zero crossover detection circuit; and
a control logic circuit, wherein the control logic circuit is configured
to determine a zero crossover point of the AC voltage in response to an output signal from the zero crossover detection circuit; and
to control the coil to actuate the relay to switch a load at the zero crossover point of a load current when the load is connected to the at least one pair of relay contacts, such that the voltage and current across the relay contacts is zero at the time the state of the at least one pair of switchable contacts changes.

9. The relay as recited in claim 1, wherein the wireless communication control is selected from the group consisting of wireless fidelity (Wi-Fi), Bluetooth, ZigBee, LoRaWAN, NFC, and RFID.

10. The relay as recited in claim 1, wherein upon energizing the coil the at least one pair of switchable contacts transition from an open state to a closed state.

11. The relay as recited in claim 1, wherein upon energizing the coil the at least one pair of switchable contacts transition from a closed state to an open state.

12. The relay as recited in claim 1, wherein upon energizing the coil to actuate the at least one pair of switchable contacts, multiple pairs of contacts are switched from a first state to a second state.

13. The relay as stated in claim 12, wherein the multiple pairs of contacts include at least one pair of contacts that transition from an open state to a closed state and at least one pair of contacts that transition from a closed state to an open state.

14. A system for controlling an industrial process, comprising:
a controller for controlling subsystems of the industrial process;
a router configured to provide wireless communications between the controller and the industrial process subsystems;
a plurality of relays configured to communicate wirelessly with the router, each of the plurality of relays having a coil and at least one pair of switchable contacts, each relay controlling at least one subsystem; and
an operator interface configured to display information relating to the industrial process, including e. g., the operating parameters and parameter set points, for an operator to observe or modify how the controller controls subsystems.

15. The industrial process control system of claim 14, wherein the industrial process control system is a building maintenance system.

16. The industrial process control system of claim 14, wherein the controller is a processor selected from the group consisting of a microprocessor and a computer.

17. The industrial process control system of claim 14, wherein the controller operates based on a predetermined set of instructions.

18. The industrial process control system of claim 14, wherein an operator can modify controller instructions utilizing the operator interface.

19. The industrial process control system of claim 14, wherein an operator interface is accessible on a mobile device to intervene in control of the industrial process.

20. The industrial process control system of claim 14, wherein the controller is coupled to an internet connection and an operator can access the operator interface using a mobile device at a location remote from a physical location of the industrial process.
